(19) United States
(12) Patent Application Publication
(10) Pub. No.: US 2026/0145076 A1
(43) Pub. Date: May 28, 2026

(54) GAME ADVERTISING SYSTEM

(71) Applicant: DeguchiLeather CO., LTD., Tatsuno-Shi (JP)

(72) Inventor: Eisaku DEGUCHI, Tatsuno-Shi (JP)

(21) Appl. No.: 19/048,960

(22) Filed: Feb. 10, 2025

Related U.S. Application Data
(63) Continuation of application No. PCT/JP2024/041763, filed on Nov. 26, 2024.

(51) Int. Cl. A63F 13/61; A63F 13/69; A63F 13/75

(52) U.S. Cl. CPC A63F 13/61; A63F 13/69; A63F 13/75; A63F 2300/5506

(57) ABSTRACT

A game advertising system 10 for advertising by attaching a mark to characters operated by players 4, the system comprising: an enterprise-side input unit 12 that allows input by a plurality of enterprises 6 that wishes a mark thereof to be attached to characters; a player-side input unit 14 for selecting a mark to be attached to each character each operated by each of the players 4 from among marks of the plurality of enterprises; an advertising-cost charging unit 16 that charges, if the mark selected by each of the players 4 is attached to the character, an advertising fee to the enterprise 6 corresponding to the selected mark; and a benefit awarding unit 18 that awards a certain benefits if each of the players 4 attaches the mark to the character.

### CROSS-REFERENCE TO RELATED APPLICATIONS

This Application claims the benefit of priority and is a Continuation application of the prior International Patent Application No. PCT/JP2024/041763, with an international filing date of Nov. 26, 2024, which designated the United States, the entire disclosures of all applications are expressly incorporated by reference in their entirety herein.

### TECHNICAL FIELD

The present invention relates to a game advertising system.

### BACKGROUND OF THE INVENTION

The spread of smartphones and tablets, as well as improvements in network and other infrastructure technologies, has led to an existing increase in the number of players enjoying online games. In online games, players need to pay charges to get items or watch advertising videos to play for free.

As a technology related to the present invention, for example, Patent Document 1 describes an advertising system that advertises via an online game that can be played using the Internet to users who play the game, the advertising system being characterized in having a server that is connected to the Internet and manages the online game, wherein the server creates a dedicated web page for the user who plays the game, using information that the user has registered with the server via the Internet, and on the user's dedicated web page, displays advertisements from advertisers registered by the user as sponsors.

### PRIOR ART

### Patent Documents

Patent Document 1: JP2004-077691A

### SUMMARY OF THE INVENTION

### Problem to be Solved By the Invention

One issue with in-game charges is that players sometimes lose control of their spending. To address this issue, it would be desirable that game players be able to play games without paying charges for games by themselves, and still receive for free various benefits that would have been obtained previously only for a charge.

The present invention is directed to providing a game advertising system that allows receiving various benefits, which would have been obtained previously only for a charge, for free without charges to be paid by players themselves, and enjoying the game.

### Means For Solving the Problems

An advertising system involving the present invention for advertising, in a game that a plurality of players connected via a network play together, by attaching a mark to characters operated by each of the players, the game advertising system comprising: an enterprise-side input unit that allows input by a plurality of enterprises that wish to attach a mark thereof to a character; a player-side input unit that allows selecting a mark to be attached to the character that players each operate from among the marks of the plurality of enterprises; an advertising-cost charging unit that charges, if the mark selected by each of the players is attached to the character, an advertising fee to the enterprise corresponding to the selected mark; and a benefit awarding unit that awards a predetermined benefit if each of the players attaches the mark to the character.

Also, it is preferable that the game advertising system involving the present invention further comprises a control processing unit that controls attaching the mark to a predetermined site of the character.

Also, it is preferable that the game advertising system involving the present invention further comprises a revocation processing unit that revokes the mark if the player operating the character bearing the mark plays in a manner that violates public order and morals.

### Effects of the Invention

The present invention allows receiving various benefits, which would have been obtained previously only for a charge, for free without charges to be paid by players themselves, and enjoying a game.

### BRIEF DESCRIPTION OF DRAWINGS

FIG. 1 is a diagram representing a game advertising system of an embodiment involving the present invention.

FIG. 2 is a diagram representing a situation in which a logo is attached to a character operated by a player in the game advertising system of the embodiment involving the present invention.

### DETAILED DESCRIPTION OF THE INVENTION

Hereinafter, a mode of embodying the present invention is explained in detail with reference to the accompanying drawings. In the following, like elements are assigned the same reference numerals in all the figures in the drawings, and a repeated description is omitted. In addition, in the description in the text, the reference numerals mentioned previously are used if necessary.

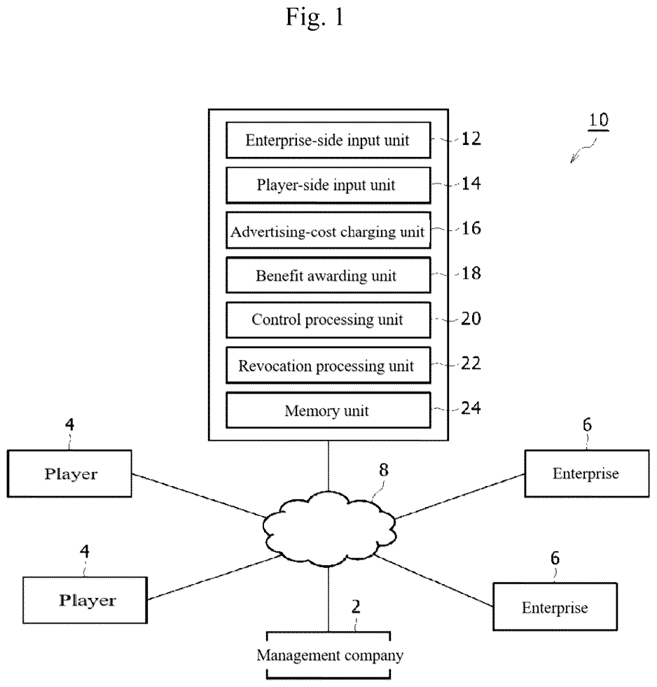

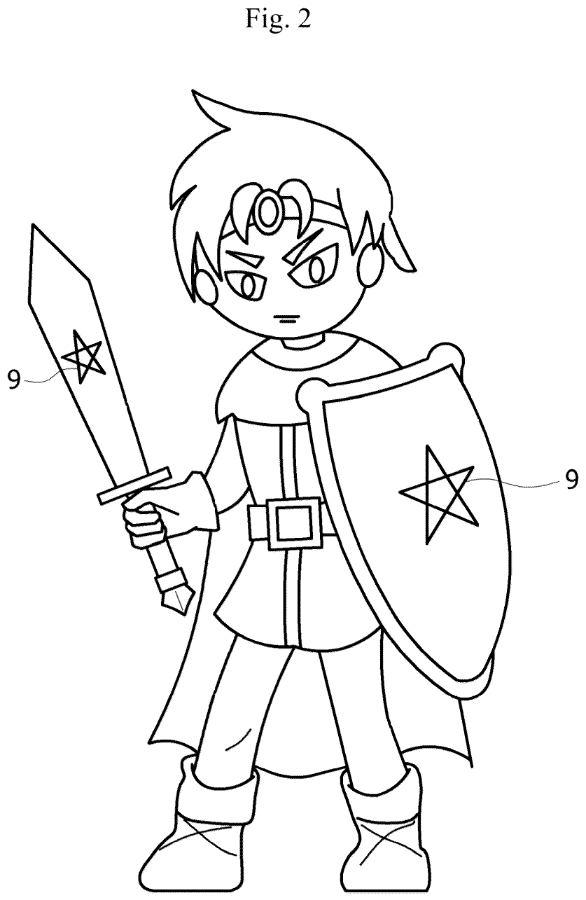

FIG. 1 is a diagram representing a game advertising system 10 of an embodiment involving the present invention. FIG. 2 is a diagram representing a situation in which a logo 9 is attached to a character operated by a player 4 in the game advertising system 10 of the embodiment involving the present invention.

The game advertising system 10 is a system for enabling the player 4 to play games without paying charges by himself/herself, and still receive for free various benefits that would have been obtained previously only for a charge. The game advertising system 10 is a system that has the function of advertising, in a game that a plurality of players 4 connected via a network 8 play together, by attaching a mark to a character operated by each player 4.

The game advertising system 10 includes an enterprise-side input unit 12, a player-side input unit 14, an advertising-cost charging unit 16, a benefit awarding unit 18, a control processing unit 20, a revocation processing unit 22, and a memory unit 24. Here, the game advertising system 10 is connected via the network 8 to a management company, a plurality of players 4, and a plurality of enterprises 6.

The management company 2 is a company that manages games that players 4 connected to each other via the network 8 play together. Examples of game types include Massively Multiplayer Online Role-Playing Games (MMORPGs) and First Person Shooters (FPSs), but of course the invention is applicable to other games as well.

The player 4 is a user who plays games managed by the management company 2. For example, in an MMORPG, the player 4 can receive a benefit by putting a logo 9 or the like of an enterprise 6 on a sword that the character operated by the player 4 carries.

The enterprise 6, being an organization that carries out business activities, is an organization that wishes its mark to be put on the character operated by the player 4 in the game, in order to advertise the products and services that it sells.

The enterprise-side input unit 12 has a function to receive input by the plurality of enterprises 6 that wish their marks to be put on the character operated by the player 4. Here, “mark” includes company logos, symbols, emblems, and other various signs. The objects on which the mark can be put include not only the character's body, but also equipment carried by the character (for example, sword, shield, armor, helmet, clothing, and footwear).

It is preferable that enterprises be in a variety of industries including fisheries, agriculture, and forestry, and manufacturers such as: food; cosmetics; pharmaceuticals; chemicals; stationery, office equipment, and interior goods; apparel, clothing, miscellaneous goods, and leather products; printing; automobiles; transport equipment; machinery; plant and engineering; general electrics; medical equipment; precision machinery, heavy electric machinery, and industrial electrical equipment; computers, communications equipment, and office equipment; semiconductors, electronic components, and others; home appliances and audio equipment; games and amusement equipment; housing; construction; facilities and facility construction; building materials and exteriors; textiles; paper and pulp; glass and ceramics; tires and rubber products; petroleum and coal; metal products; non-ferrous metals; steel, mining, and cement; and agriculture, forestry, and fisheries.

Additionally, examples of industries include services and infrastructures such as: travel; hotels; leisure, amusement, and pachinko; performing arts and arts; sports-, fitness-, and health-related facilities; education; real estate; public corporations and government agencies; aviation and airports; railways; shipping; land transport; taxis, buses, and tourist buses; warehouses; electricity and power; energy; gas and water supplies; eating out, restaurants, and food services; human resources services (employment agencies and temporary staffing); consultants and specialized consultants; construction consultants; think tanks; medical and healthcare facilities; welfare and nursing care; bridal and funerals; esthetic, barbering, and beauty salons; organizations and associations; architectural design; security, safety, maintenance, and cleaning; and mechanical design.

Examples of industries also include trading companies (general and specialized) such as: general trading companies; food products; chemical products; cosmetics; pharmaceuticals; textile products; apparel, clothing accessories, and precious metals; interior goods; sporting goods; education; machinery; medical equipment; automobiles and transport equipment; office equipment; electrical, electronic and semiconductor products; metals; building materials and exteriors; paper; and petroleum products. Additionally, examples of industries include the banking, securities, insurance, and finance sectors such as: city banks and trust banks; local banks; cooperative banks, credit associations, labor banks, and mutual aid associations; foreign financial institutions; government-affiliated and affiliated financial institutions; life insurance; casualty insurance; securities; credit sales and loans; leasing and rental; and consumer finances.

Furthermore, examples of industries include information (advertising, communications, and mass media) such as: advertising; publishing and magazines; broadcasting, televisions, and radios; newspapers; and communications. Moreover, examples of industries include department stores, specialty stores, distribution and retail businesses such as: department stores and shopping complexes; supermarkets and shops; convenience stores; hardware stores; consumer cooperatives; music, books, and interior goods; fashion, clothing accessories, and textiles; drugstores, pharmaceuticals, cosmetics, and dispensing pharmacies; sporting goods; automobiles and transportation equipment; home appliances, office equipment, and cameras; and glasses, contact lenses, and medical equipment. Additionally, examples of industries include IT, software, and information processing such as: information processing; software; the Internet; the Web; smartphone apps; and game software.

The player-side input unit 14 has a function to select a mark to be put on each character operated by each player 4 from among the marks of the plurality of enterprises 6. In the game advertising system 10, as described above, since a wide variety of enterprises 6 participate, the players 4 can select an enterprise 6 that they like or that they want to support.

For example, if they have a favorite apparel brand, they can select that enterprise 6, or if they have a favorite automobile manufacturer, they can select that enterprise 6, or they can select a hardware store that he/she regularly uses. In addition to selecting a favorite enterprise 6 that they like, they can also select an enterprise 6 that they want to support, such as an enterprise 6 that positively employs people with disabilities or promotes the SDGs.

The advertising-cost charging unit 16 has a function to charge, if a mark selected by each player 4 is put on the character, advertising fees to the enterprise 6 corresponding to the selected mark. For example, in an MMORPG, when a character operated by the player 4 who has selected a weapon bearing the logo 9 of the enterprise 6 that the player supports appears like the character illustrated in FIG. 2, a fee is charged to the enterprise 6 corresponding to the logo 9.

It should noted that, here, while the logo has been described as being on a weapon, it may be put on the character's body itself, or may be applied to various equipment such as protective gear rather than a weapon.

The benefit awarding unit 18 has a function to award a certain benefit if each player 4 puts a mark on a character. Thus, for the benefits for which the player 4 would have paid the charge by himself/herself in online games previously, in exchange for displaying the logo 9 of the enterprise 6 on the character operated by the player 4, the enterprise 6 pays the charge on behalf of the player 4 to the management company 2 as the advertising fee.

As the benefits, in MMORPGs, by putting the logo 9 on costumes or arms, or by attaching them directly to a character (avatar), players are rewarded with special items such as a few percent increase in attack power or a few percent increase in defense power, or an increase in the number of items dropped for winning a battle. Also, in MMORPGs, by placing the logo 9 on transportation means such as a carriage, it is possible to make movement faster or make encounters more likely (or less likely).

In shooting games, for having the logo 9, players can be rewarded with benefits such as extra lives, invincibility for a certain period of time, or more bullets for a certain period of time. Furthermore, by attaching the logo to buildings, players can receive various bonuses such as faster life recovery, obtain premium buildings in miniscape games, or use rental servers, etc.

The control processing unit 20 has a function to control putting a mark on a predetermined site of a character. A plurality of enterprises 6 wishing their marks to be put on the character operated by the player 4 can control the site for attaching the mark on the basis of their policies, etc. Here, the site for attaching the mark is described as being set by the enterprise 6, but it may also be set by the management company 2.

For example, the control processing unit 20 can prohibit placing the mark to the crotch area of a character. Also, manufacturers selling infant products, for example, may have control against offensive weapons such as swords, as they may be concerned about damaging their public image.

The revocation processing unit 22 has a function to revoke a mark when the player 4 who operates a character bearing the mark plays in a manner that violates public order and morals. The management company 2 can set it up so that if, for example, a player cheats in a game or plays in a way that harms public order or good morals, the mark will be taken away as they may be concerned about damaging the enterprise's public image.

This is expected to make the players 4 be more aware that the logo 9 of the enterprise 6 is being used, and play by the rules.

The memory unit 24 can store information that has been input or set in the enterprise-side input unit 12, the player-side input unit 14, the advertising-cost charging unit 16, the benefit awarding unit 18, the control processing unit 20, and the revocation processing unit 22.

Each function of the game advertising system 10 can be realized by either a hardware configuration or a software configuration. For example, when these functions are realized by software, they can be realized by having application software stored in a recording medium, such as a RAM, a ROM, or hard disk, run on a server device configured with a CPU, an MPU, a RAM, a ROM, etc.

The action of the game advertising system 10 with the above-described configuration will now be explained. In the game advertising system 10, an enterprise 6 that wishes its mark (logo 9 or the like) to be put on a character operated by a player 4 uses an enterprise-side input unit 12 for input. Since it is preferable that the player 4 select the enterprise that he/she wants to support, it is suitable that the types of business of a plurality of enterprises 6 include a wide variety of industries.

When the player 4 participates in a game, the player 4 can select whether or not to put the mark of the enterprise 6 on a character. For example, in an MMORPG, when the character enters a weapon shop, the player can freely select between a weapon bearing the mark (logo 9 or the like) of the enterprise 6 and a weapon bearing no mark. Here, while the weapon shop is taken as an example, it may be possible to select when entering other stores or booths. Here, while it is assumed that the weapon bears a mark in advance for description purposes, the player 4 may freely decide the position on the weapon where the mark is carried.

When a weapon bearing the mark of the enterprise 6 is selected, the player 4 can also select an enterprise 6 that he/she wants to support (for example, a manufacturer of a product that he/she regularly uses or an enterprise that promotes the SDGs). It is preferable that the enterprises 6 include a wide variety of industries, but once the player 4 has made a selection, the enterprises 6 preferred by the player 4 may be displayed preferentially.

When the logo 9 of the enterprise 6 selected by the player 4 is displayed in a form such as that illustrated in FIG. 2, it is as if a sponsorship contract was concluded between the player 4 and the enterprise 6 of the logo 9, and an advertising fee is paid to the management company 2.

The advertising fee paid by the enterprise 6 to the management company 2 is applied to the expenses necessary for the benefits that the player 4 would have obtained conventionally only for a charge by himself/herself, and the player 4 can receive the benefits for free. Examples of benefits include, in shooting games, extra lives, invincibility for a certain period of time, and more bullets for a certain period of time. In MMORPGs, players can receive an attack power-up or a defense power-up, or be rewarded with special items. It is also possible that during battle, the logo 9 of the enterprise 6 be displayed as an effect, so long as it does not adversely affect the game balance.

Furthermore, in a situation in which the player 4 can freely decide the position on the character where the mark of the enterprise 6 is to be attached, the enterprise 6 can control the target site for attaching the mark. For example, this is to prevent damage to the public image of the enterprise when the mark of the enterprise 6 is attached to the character's crotch.

If the player 4 uses a character to perform an obscene act or a discriminatory act, or otherwise engage in an act that is offensive to public order and morals, the mark of the enterprise 6 may be revoked in order to prevent damage to the public image of the enterprise.

The player 4 will be in a position as if they had a sponsorship contract with enterprise 6, and will be expected to strive for better gameplay as if they were representing the enterprise 6. In addition, in open world games, etc., it is expected that a sense of solidarity will be created by finding other game users who are also using the same logo 9 or the like.

In this way, since the logo 9 or other marks can be seen by many players 4 participating in the game, it serves as advertising for the enterprise 6 and enables the enterprise 6 to show its approval and support for CSR efforts to other players 4. Additionally, enterprise 6 may promote company and product information in in-game information emails and the like.

Here in the above description, the sponsor of the player 4 is an enterprise 6, but the sponsor may be an individual rather than an organization. For example, in elections, as long as the laws of the relevant country are complied with, enterprises, organizations, individuals, etc. that support candidates may become sponsors and display small items such as charms, bracelets, handkerchiefs, etc. instead of a mark.

### DESCRIPTION OF REFERENCE NUMERALS

2: Management company 4: Player 6: Enterprise 8: Network 9: Logo 10: Game advertising system 12: Enterprise-side input unit 14: Player-side input unit 16: Advertising-cost charging unit 18: Benefit awarding unit 20: Control processing unit 22: Revocation processing unit 24: Memory unit

1. A game advertising system for advertising, in a game that a plurality of players connected via a network play together, by attaching a mark to characters operated by each of the players, the game advertising system comprising:
an enterprise-side input unit that allows input by a plurality of enterprises that wish a mark thereof to be attached to a character;
a player-side input unit that allows selecting a mark to be attached to the character that players each operate from among the marks of the plurality of enterprises;
an advertising-cost charging unit that charges, if the mark selected by each of the players is attached to the character, an advertising fee to the enterprise corresponding to the selected mark; and
a benefit awarding unit that awards a predetermined benefit if each of the players attaches the mark to the character.

2. The game advertising system according to claim 1, further comprising:
a control processing unit that controls attaching the mark to a predetermined site of the character.

3. The game advertising system according to claim 1, further comprising:
a revocation processing unit that revokes the mark if the player operating the character bearing the mark plays in a manner that violates public order and morals.
